(19) United States
(12) Patent Application Publication
(10) Pub. No.: US 2026/0300768 A1
(43) Pub. Date: Oct. 1, 2026

(54) STATE PREDICTION APPARATUS, CONTROL APPARATUS, AND STATE PREDICTION METHOD

(71) Applicant: NEC Corporation, Tokyo (JP)

(72) Inventors: Junya Ikemoto, Ibaraki (JP); Shumpei Kubosawa, Ibaraki (JP); Takashi Onishi, Ibaraki (JP)

(73) Assignee: NEC Corporation, Tokyo (JP)

(21) Appl. No.: 19/567,526

(22) Filed: Mar. 16, 2026

(30) Foreign Application Priority Data
Mar. 25, 2025 (JP) 2025-049403

(51) Int. Cl. G06N 5/022

(52) U.S. Cl. CPC G06N 5/022

(57) ABSTRACT

A state prediction apparatus includes a meta-mode determination unit that selects some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and a mode estimation unit that estimates a mode of state transition of the state prediction target at the state prediction start time based on a selected candidate of the mode of state transition of the state prediction target at the state prediction start time, the state data, and the input data.

### INCORPORATION BY REFERENCE

This application is based upon and claims the benefit of priority from Japanese patent application No. 2025-049403, filed on Mar. 25, 2025, the disclosure of which is incorporated herein in its entirety by reference.

### TECHNICAL FIELD

The present disclosure relates to a state prediction apparatus, a control apparatus, a state prediction method, and a program.

### BACKGROUND ART

Processing according to a state of a target may be performed, for example, in a case of controlling the target whose state changes.

For example, WO 2022/208860 A1 describes deriving a control law that satisfies a required specification including a specification regarding a time required for state transition by using a model including a set of states of devices including a control target, a set of input signals for the control target, and a time required for the state transition, and generating a program to be executed by a controller that controls the control target based on the derived control law.

### SUMMARY

It is conceivable to predict a future state of a target, such as in a case of performing processing according to the state of the target.

At the time of predicting the future state of the target, it is preferable that the state of the target can be predicted with as high accuracy as possible even in a case where the mode obtained by dividing the state transition law (manner of state change) of the target cannot be uniquely specified.

An example object of the present disclosure is to provide a state prediction apparatus, a control apparatus, a state prediction method, and a program that can solve the above problems.

According to a first example aspect of the present disclosure, a state prediction apparatus includes a meta-mode determination means for selecting some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and a mode estimation means for estimating a mode of state transition of the state prediction target at the state prediction start time based on a selected candidate of the mode of state transition of the state prediction target at the state prediction start time, the state data, and the input data.

According to a second example aspect of the present disclosure, a control apparatus includes a meta-mode determination means for selecting some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, a mode estimation means for estimating a mode of state transition of the state prediction target at the state prediction start time based on a selected candidate of the mode of state transition of the state prediction target at the state prediction start time, the state data, and the input data, and a control command generation means for generating a control command with respect to the state prediction target based on an estimation result of the mode.

According to a third example aspect of the present disclosure, a state prediction method includes having a computer to select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and estimate a mode of state transition of the state prediction target at the state prediction start time based on a selected candidate of the mode of state transition of the state prediction target at the state prediction start time, the state data, and the input data.

According to a fourth example aspect of the present disclosure, a program is a program for causing a computer to select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and estimate a mode of state transition of the state prediction target at the state prediction start time based on a selected candidate of the mode of state transition of the state prediction target at the state prediction start time, the state data, and the input data.

According to the aspects of the present disclosure, it is expected that a state of a target can be predicted with relatively high accuracy even in a case where a mode obtained by dividing the state transition law of the target cannot be uniquely specified.

### BRIEF DESCRIPTION OF THE DRAWINGS

The above and other aspects, features and advantages of the present disclosure will become more apparent from the following description of certain exemplary embodiments, taken in conjunction with the accompanying drawings, in which:

FIG. 1 is a diagram illustrating an example of a configuration of a state prediction system according to at least one example embodiment;

FIG. 2 is a diagram illustrating an example of a configuration of a state prediction apparatus according to at least one example embodiment;

FIG. 3 is a diagram illustrating an example of a mode of state transition of a state prediction target according to at least one example embodiment;

FIG. 4 is a diagram illustrating an example of calculation of a belief vector by a mode estimation unit according to at least one example embodiment;

FIG. 5 is a diagram illustrating an example of a belief calculated by the mode estimation unit according to at least one example embodiment;

FIG. 6 is a diagram illustrating an example of an estimation mode vector according to at least one example embodiment;

FIG. 7 is a diagram illustrating an example of a configuration of a mode estimator according to at least one example embodiment;

FIG. 8 is a diagram illustrating an example of an application scene of state prediction by the state prediction apparatus according to at least one example embodiment;

FIG. 9 is a diagram illustrating an example of a configuration of a control system according to at least one example embodiment;

FIG. 10 is a diagram illustrating an example of a configuration of a control apparatus according to at least one example embodiment;

FIG. 11 is a diagram illustrating an example of a configuration of a state prediction apparatus according to at least one example embodiment;

FIG. 12 is a diagram illustrating an example of a configuration of a control apparatus according to at least one example embodiment;

FIG. 13 is a diagram illustrating an example of a procedure of processing in a state prediction method according to at least one example embodiment; and

FIG. 14 is a diagram illustrating an example of a configuration of a computer according to at least one example embodiment.

### EXAMPLE EMBODIMENT

Hereinafter, example embodiments will be described with reference to the drawings.

Hereinafter, there is a case where a character to which a dot symbol is added above is represented by adding “^{⋅}” after the character. For example, x to which a dot symbol is added above is also denoted as x′.

In addition, a character to which a circumflex is attached may be represented by adding “A” after the character. For example, I to which a circumflex is attached is also denoted as I\hat{ }.

### First Example Embodiment

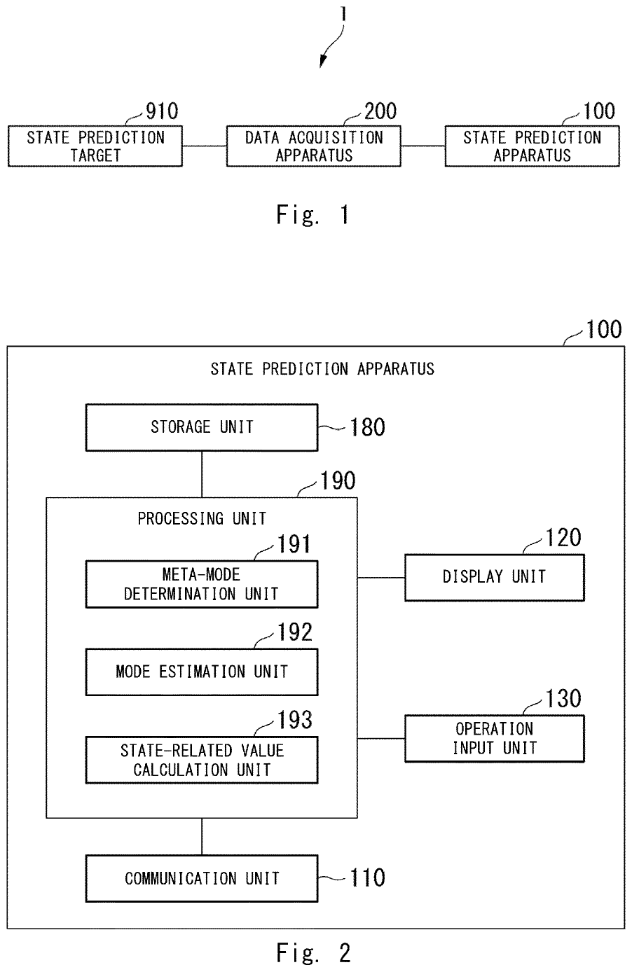

FIG. 1 is a diagram illustrating an example of a configuration of a state prediction system according to at least one example embodiment. In the configuration illustrated in FIG. 1, a state prediction system 1 includes a state prediction apparatus 100 and a data acquisition device 200. In addition, FIG. 1 illustrates a state prediction target 910.

The state prediction apparatus 100, the data acquisition apparatus 200, and the state prediction target 910, or a part thereof may be integrally configured. For example, the state prediction apparatus 100 may include the data acquisition apparatus 200. Alternatively, the state prediction target 910 may include the data acquisition apparatus 200.

The state prediction system 1 predicts the state of the state prediction target 910.

The state prediction target 910 is a target of state prediction in the state prediction system 1. The state prediction target 910 is not limited to a specific target, and may be various targets whose state changes according to an input to the state prediction target 910. For example, the state prediction target 910 may be a device such as a machine tool, a robot, or a moving body (e.g., a vehicle, a drone, etc.). Alternatively, the state prediction target 910 may be a system including a plurality of machines, such as a chemical plant, a factory such as an iron manufacturing plant or a machine manufacturing factory, a production line in a factory, or a power plant. Alternatively, the state prediction target 910 may be a natural environment such as the atmosphere, river, or soil.

The input to the state prediction target 910 may be a control command for controlling the state prediction target 910, but is not limited thereto. For example, the input to the state prediction target 910 may be some kind of energy applied to the state prediction target 910 from the outside of the state prediction target 910, such as heat applied to the state prediction target 910 from the operating environment of the state prediction target 910, physical force, or light emitted on the state prediction target 910, or a combination thereof.

The state prediction target 910 may be configured as a part of the state prediction system 1 or may be configured outside the state prediction system 1.

The data acquisition apparatus 200 acquires data used for state prediction of the state prediction target 910, and outputs (transmits) the acquired data to the state prediction apparatus 100.

In particular, the data acquisition apparatus 200 acquires data indicating the state of the state prediction target 910. For example, the data acquisition apparatus 200 may include a sensor, and acquire sensor data (data measured by the sensor) for specifying the state of the state prediction target 910. Alternatively, the state prediction target 910 may output data indicating the state of the state prediction target 910. Then, the data acquisition apparatus 200 may acquire data output from the state prediction target 910 in addition to or instead of the sensor data.

Data indicating the state of the state prediction target 910 is also referred to as state data.

Furthermore, in a case where the output source of the input to the state prediction target is not the state prediction apparatus 100, the data acquisition apparatus 200 may acquire data indicating the input to the state prediction target in addition to the state data. For example, in a case where the input to the state prediction target 910 is energy applied from the outside of the state prediction target 910, the data acquisition apparatus 200 may measure the energy applied to the state prediction target 910 by including a sensor or the like, and output energy measurement data to the state prediction apparatus 100.

Data indicating an input to the state prediction target 910 is also referred to as input data.

The state prediction apparatus 100 predicts the state of the state prediction target 910 based on the state data and the input data. In particular, the state prediction apparatus 100 predicts the state of the state prediction target 910 at a time later than the time indicated by the state data and the input data. That is, the state prediction apparatus 100 predicts the state of the state prediction target 910 at the state prediction start time based on the state data indicating the state of the state prediction target 910 at the time before the state prediction start time and the input data indicating the input to the state prediction target 910 at the time before the state prediction start time.

The state prediction apparatus 100 may be configured using a computer, or may be configured using an Application Specific Integrated Circuit (ASIC) or a Field Programmable Gate Array (FPGA).

FIG. 2 is a diagram illustrating an example of a configuration of the state prediction apparatus 100. In the configuration illustrated in FIG. 2, the state prediction apparatus 100 includes a communication unit 110, a display unit 120, an operation input unit 130, a storage unit 180, and a processing unit 190. The processing unit 190 includes a meta-mode determination unit 191, a mode estimation unit 192, and a state-related value calculation unit 193.

The communication unit 110 communicates with other devices. For example, the communication unit 110 may receive the state data and the input data from the data acquisition apparatus 200. Furthermore, in a case where the state prediction apparatus 100 is configured as a control apparatus for controlling the state prediction target 910, the communication unit 110 may transmit a control command to the state prediction target 910.

The display unit 120 has a display screen such as, for example, a liquid crystal panel or a Light Emitting Diode (LED) panel, and displays various images. For example, the display unit 120 may display the prediction result of the state of the state prediction target 910 by the state prediction apparatus 100.

The operation input unit 130 is configured to include, for example, an input device such as a keyboard and a mouse, and accepts a user operation. For example, the operation input unit 130 may accept a user operation of setting a parameter value related to state prediction, such as a learning rate of a machine learning model for state prediction.

The storage unit 180 stores various data. For example, the storage unit 180 may store the time-series data of the state of the state prediction target 910 and the time-series data of the input to the state prediction target. The storage unit 180 is configured using a storage device included in the state prediction apparatus 100.

The processing unit 190 controls each unit of the state prediction apparatus 100 to perform various types of processing. The function of the processing unit 190 is executed, for example, in a case where a Central Processing Unit (CPU) included in the state prediction apparatus 100 reads a program from the storage unit 180 and executes the program.

The meta-mode determination unit 191 limits the mode of state transition of the state prediction target 910 at the state prediction start time based on the state data and the input data before the state prediction start time. Specifically, the meta-mode determination unit 191 selects some of the modes assumed as the mode of the state transition of the state prediction target 910 as the candidates of the mode of state transition of the state prediction target 910 at the state prediction start time. The meta-mode determination unit 191 corresponds to an example of a meta-mode determination means.

Here, it is assumed that the state data is indicated by a continuous value (e.g., a real number vector). In addition, it is assumed that, in the state prediction target 910, each section delimited by an internal parameter of the state prediction target 910 that is not included in the range of values that can be taken by the state data or the state is set as the mode of state transition of the state prediction target 910. The mode of state transition of the state prediction target 910 can be regarded as a hidden internal state represented by a discrete value of the state prediction target 910.

The value of the state data is also referred to as a state value.

Estimating the mode of state transition of the state prediction target 910 corresponds to estimating a hidden internal state of the state prediction target 910.

The state prediction apparatus 100 may estimate the mode of state transition of the state prediction target 910 and further predict the state value. Estimating the mode of state transition of the state prediction target 910 and predicting the state value also correspond to an example of predicting the state of the state prediction target 910.

The mode of state transition of the state prediction target 910 is also referred to as a state transition mode or simply a mode.

That the state value at the state prediction start time is included in a certain mode can be referred to as that the mode at the state prediction start time is the mode (mode including the state value).

That the state value at the state prediction start time is included in a certain meta-mode can be referred to as that the meta-mode at the state prediction start time is the meta-mode (meta-mode including the state value).

Here, it is assumed that there is a case where the mode cannot be uniquely specified from the data acquired by the state prediction apparatus 100. On the other hand, it is assumed that the mode can be limited (narrowed down) to one or a plurality of modes based on the data acquired by the state prediction apparatus 100, and a set of one or a plurality of modes that can be limited is referred to as a meta-mode. The meta-mode can be regarded as a set in which modes are classified. That is, the meta-mode can be regarded as a range of values that can be taken by the state data divided into a set of modes.

The meta-mode determination unit 191 determines the meta-mode at the state prediction start time based on the data (state data and input data) acquired by the state prediction apparatus 100. The meta-mode at the state prediction start time is a meta-mode including a state value at the state prediction start time.

Specifically, the meta-mode determination unit 191 selects any one of the meta-modes. The selection of the meta-mode by the meta-mode determination unit 191 can be regarded as selecting some of the modes assumed as the mode of state transition of the state prediction target 910. Furthermore, the selection of the meta-mode by the meta-mode determination unit 191 can also be regarded as performing limitation of modes (narrowing down of modes).

The mode estimation unit 192 estimates the mode of the state prediction target 910 using the mode included in the meta-mode selected by the meta-mode determination unit 191 as a candidate of the mode of state transition of the state prediction target 910. The mode estimation unit 192 corresponds to an example of a mode estimation means.

Specifically, for each of the modes included in the meta-mode selected by the meta-mode determination unit 191, the mode estimation unit 192 calculates a value indicating a degree of possibility that the mode at the state prediction start time is the mode. A value indicating the degree of possibility that the mode at the state prediction start time is a certain mode is also referred to as Belief. Belief can also be referred to as Likelihood.

The belief calculated by the mode estimation unit 192 may be used as the mode estimation result by the mode estimation unit 192. Alternatively, the mode estimation unit 192 may select any one mode based on a belief such as selecting a mode having the largest (value of) belief among the modes included in the meta-mode selected by the meta-mode determination unit 191. In this case, the mode selected by the mode estimation unit 192 may be used as the mode estimation result by the mode estimation unit 192.

The state-related value calculation unit 193 calculates a value related to the state of the state prediction target 910 based on the estimation result of the mode by the mode estimation unit 192 by using the prediction model provided for each mode. The state-related value calculation unit 193 corresponds to an example of a state-related value calculation means.

Hereinafter, a case where the state-related value calculation unit 193 calculates a derivative of a state value by using a Neural Ordinary Differential Equation (Neural ODE) as a prediction model will be described as an example. The change amount in the state value can be calculated by integrating the differential of the state value. The prediction value of the state value can be calculated by adding the change amount to the original state value (state value before change). The integration of the differential of the state value can be approximately calculated by multiplying the differential of the state value by time for a time step.

In addition, it is also possible to construct a continuous time model as illustrated in Formula (1) by using a Neural Ordinary Differential Equation.

$$\begin{matrix}[ Mathematical formula 1 ] & \\ \dot{x} ( t ) = f ( x ( t ) , u ( t ) ) & ( 1 )\end{matrix}$$

x(t) represents a state value of the state prediction target 910 at time t. x^{⋅}(t) represents a time derivative of the state value x(t).

u(t) represents an input to the state prediction target 910.

f is a function representing a continuous time model.

The stability or safety of the state prediction target 910 can be analyzed in advance by constructing such a continuous time model. Furthermore, in the case of performing control on the state prediction target 910, it is possible to formulate an optimal control problem of the state prediction target 910 and design a feedback controller for controlling the state of the state prediction target 910 by differentiable model-based policy optimization, gradient model-based reinforcement learning, or the like. Furthermore, an online control method such as model predictive control or Moving Horizon Estimation can be used for the control on the state prediction target 910.

However, the value calculated by the state-related value calculation unit 193 is not limited to the time derivative of the state value, and may be various values related to the state of the state prediction target 910. For example, the state-related value calculation unit 193 may directly predict the state value without going through time derivative of the state value. Alternatively, the state-related value calculation unit 193 may calculate a control command for the state prediction target 910. Calculating a control command for the state prediction target 910 can be regarded as calculating a command value for having the state prediction target 910 to a desired state.

Furthermore, the prediction model used by the state-related value calculation unit 193 is not limited to the neural differential equation, and may be various models. For example, the state-related value calculation unit 193 may use any one of a linear model, a piecewise linear model, Sparse Identification of Nonlinear Dynamics (SINDy), a control affine model, a neural ordinary differential equation in which regularization and dropout are strengthened, or an Augment Incomplete Physical Models for Identifying and Forecasting Complex Dynamics (APHYNITY) model as the prediction model.

Furthermore, in a case where the complexity of the behavior of the state of the state prediction target 910 differs depending on the mode, or the like, the state-related value calculation unit 193 may use different types of models for each mode.

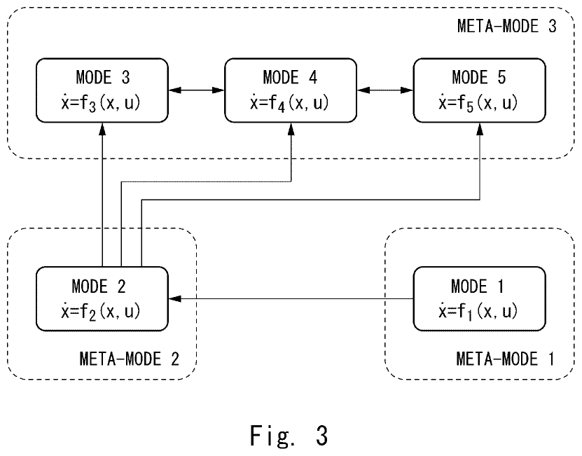

FIG. 3 is a diagram illustrating an example of a mode of state transition of the state prediction target 910.

In the example of FIG. 3, five modes from mode 1 to mode 5 are set as the mode of the state prediction target 910. Mode 1 is included in meta-mode 1, mode 2 is included in meta-mode 2, and mode 3, mode 4, and mode 5 are included in meta-mode 3. In addition, the state-related value calculation unit 193 includes a Neural Ordinary Differential Equation for each mode.

Hereinafter, both the determination result of the meta-mode by the meta-mode determination unit 191 and the estimation result of the mode by the mode estimation unit 192 are expressed by vectors.

The vector indicating the determination result of the meta-mode by the meta-mode determination unit 191 is also referred to as a meta-mode vector. The meta-mode vector can be expressed as Formula (2).

$$\begin{matrix}[ Mathematical formula 2 ] & \\ J ( t ) = [ \begin{matrix}{J}_{1} ( t ) \\ {J}_{2} ( t ) \\ ⋮ \\ {J}_{N} ( t )\end{matrix} ] & ( 2 )\end{matrix}$$

J(t) is a meta-mode vector indicating the determination result of the meta-mode at time t.

N indicates the number of meta-modes.

An element Jⱼ(t) of the vector J(t) indicates whether the j-th meta-mode is selected. Here, j is an integer such that 1≤j≤N. A case where the meta-mode determination unit 191 selects the j-th meta-mode is expressed as Jⱼ(t)=1, and a case where it does not select the j-th meta-mode is expressed as Jⱼ(t)=0.

As described above, the meta-mode determination unit 191 selects any one meta-mode. Therefore, the meta-mode vector becomes a one-hot vector.

For example, in a case where the meta-mode determination unit 191 selects the second meta-mode (meta-mode 2), the meta-mode vector is indicated by a one-hot vector in which the second element is 1 and the other elements are 0 as in Formula (3).

$$\begin{matrix}[ Mathematical formula 3 ] & \\ J ( t ) = [ \begin{matrix}0 \\ 1 \\ 0 \\ ⋮ \\ 0\end{matrix} ] & ( 3 )\end{matrix}$$

A vector indicating a mode is also referred to as a mode vector. A mode vector I (t) indicating a mode at time t is expressed by Formula (4).

$$\begin{matrix}[ Mathematical formula 4 ] & \\ I ( t ) = [ \begin{matrix}{I}_{1} ( t ) \\ {I}_{2} ( t ) \\ ⋮ \\ {I}_{M} ( t )\end{matrix} ] & ( 4 )\end{matrix}$$

M represents the number of modes.

The element Iᵢ(t) of the mode vector I(t) indicates whether the i-th mode is the mode at time t. Here, i is an integer such that 1≤i≤M. A case where the i-th mode is the mode at time t is expressed as Iᵢ(t)=1, and a case where the i-th mode is not the mode at time t is expressed as Iᵢ(t)=0.

Here, it is assumed that the modes are set exclusively to each other. That is, it is assumed that any state value is included in any one mode. Therefore, the mode vector I(t) is a one-hot vector.

However, as described above, it is assumed that there is a case where the state prediction apparatus 100 cannot uniquely specify the mode. Therefore, the mode estimation unit 192 may not be able to directly know the mode vector I(t).

Therefore, the mode estimation unit 192 calculates the above-described belief instead of calculating the mode vector. The mode estimation unit 192 calculates a belief of each of the modes included in the meta-mode selected by the meta-mode determination unit 191 to a value of equal to or greater than 0, and sets the belief to 0 for the mode not selected by the meta-mode determination unit 191.

A vector having a belief for each mode as an element is also referred to as a belief vector.

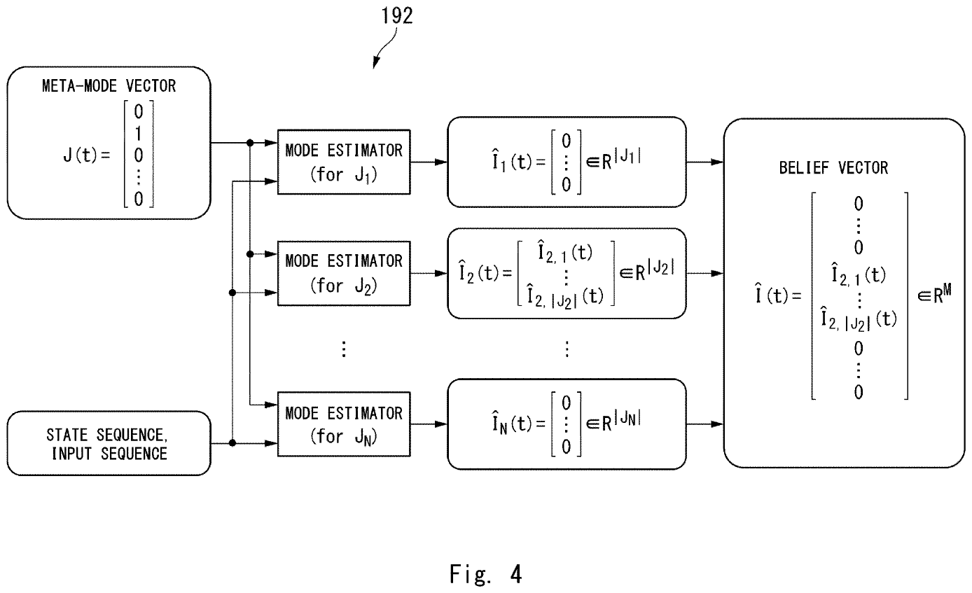

FIG. 4 is a diagram illustrating an example of calculation of a belief vector by the mode estimation unit 192. FIG. 4 illustrates an example of a case in which the mode estimation unit 192 calculates the belief vector using the mode estimator for each meta-mode.

For the meta-mode in which the element of the meta-mode vector is 1, the mode estimator calculates the belief of each mode included in the meta-mode based on the time-series data of the state value of the state prediction target 910 and the time-series data of the input to the state prediction target 910. In this case, the mode estimator calculates the belief such that the belief of any mode has a real value of equal to or greater than 0.

On the other hand, for the meta-mode in which the element of the meta-mode vector is 0, the mode estimator calculates the belief of each mode included in the meta-mode as 0.

The time-series data of the state value of the state prediction target 910 is also referred to as a state sequence. The time-series data of the input to the state prediction target 910 is also referred to as an input sequence.

The mode estimation unit 192 generates a belief vector by collecting the belief calculated using the mode estimator for all the modes.

The belief vector I\hat{ }(t) at time t is expressed by Formula (5).

$$\begin{matrix}[ Mathematical formula 5 ] & \\ \hat{I} ( t ) = [ \begin{matrix}{\hat{I}}_{1} ( t ) \\ {\hat{I}}_{2} ( t ) \\ ⋮ \\ {\hat{I}}_{M} ( t )\end{matrix} ] & ( 5 )\end{matrix}$$

M represents the number of modes. With i as an integer such that 1≤i≤M, I\hat{ }ᵢ(t) indicates a belief of the i-th mode (mode i) at time t.

In a case where the distinction of the meta-modes is indicated, the belief vector I\hat{ }(t) can also be expressed as Formula (6).

$$\begin{matrix}[ Mathematical formula 6 ] & \\ \hat{I} ( t ) = [ \begin{matrix}{\hat{I}}_{1 , 1} ( t ) \\ ⋮ \\ {\hat{I}}_{1 , \vert {J}_{1} \vert} ( t ) \\ ⋮ \\ {\hat{I}}_{N , 1} ( t ) \\ ⋮ \\ {\hat{I}}_{N , \vert {J}_{N} \vert} ( t )\end{matrix} ] & ( 6 )\end{matrix}$$

N indicates the number of meta-modes.

|Jⱼ| indicates the number of modes included in the j-th meta-mode (meta-mode j). Here, j is an integer such that 1≤j≤N.

I\hat{ }_{j, i}(t) indicates a belief of the i-th mode of the j-th meta-mode at time t. Here, i is an integer such that 1≤i≤|Jⱼ|.

The i-th mode of the j-th meta-mode is also referred to as a mode j, i.

The partial vector I\hat{ }ⱼ(t) of the belief vector at time t for the j-th meta-mode can be expressed as Formula (7).

$$\begin{matrix}[ Mathematical formula 7 ] & \\ {\hat{I}}_{j} ( t ) = [ \begin{matrix}{\hat{I}}_{j , 1} ( t ) \\ {\hat{I}}_{j , 2} ( t ) \\ ⋮ \\ {\hat{I}}_{j , \vert {J}_{j} \vert} ( t )\end{matrix} ] & ( 7 )\end{matrix}$$

FIG. 4 illustrates an example of a case in which the meta-mode determination unit 191 selects the second meta-mode. The mode estimation unit 192 calculates a belief of each mode of the second meta-mode to be a real value of equal to or greater than 0, and calculates a belief of each mode of the other meta-modes as 0.

R^{k} represents an R-dimensional real space. Here, k is an integer such that k≥1.

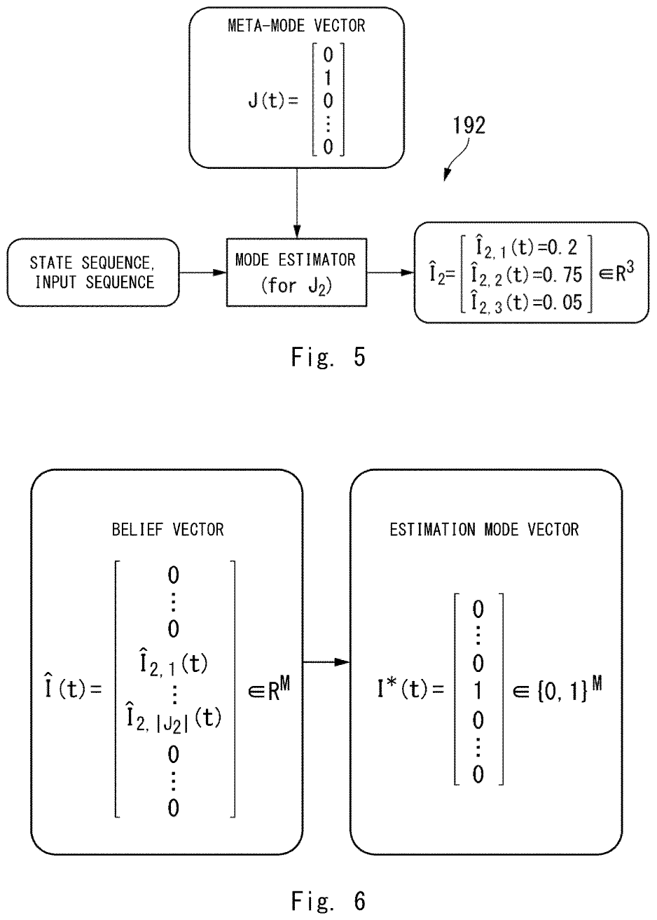

FIG. 5 is a diagram illustrating an example of a belief calculated by the mode estimation unit 192. FIG. 5 illustrates an example of a case in which the meta-mode determination unit 191 selects the second meta-mode, and the number of modes included in the second meta-mode is three.

In the example of FIG. 5, the mode estimation unit 192 calculates the belief I\hat{ }_{2, 1}(t) of the first mode of the second meta-mode as 0.2, calculates the belief I\hat{ }_{2, 2}(t) of the second mode of the second meta-mode as 0.75, and calculates the belief I\hat{ }_{2, 3}(t) of the third mode of the second meta-mode as 0.05.

As described above, the mode estimation unit 192 calculates the belief of each mode included in the meta-mode selected by the meta-mode determination unit 191 to be a real value of equal to or greater than 0.

Furthermore, the mode estimation unit 192 calculates the belief such that the total of the beliefs of the modes included in the second meta-mode becomes 1. As described above, the mode estimation unit 192 calculates the belief of the mode included in the meta-mode that is not selected by the meta-mode determination unit 191 as 0. Therefore, the mode estimation unit 192 calculates the belief of each mode in such a way that the total of the beliefs of all the modes becomes 1. The belief in this case can be grasped as a probability that the mode at the state prediction start time is the mode (mode associated with the belief).

The mode estimation unit 192 may calculate a one-hot vector in which the value of one element having the largest value among the elements of the belief vector is set to 1 and the values of the other elements are set to 0 as the estimation result of the mode in the state prediction target.

The one-hot vector in this case is also referred to as an estimation mode vector. The estimation mode vector I*(t) can be expressed as Formula (8).

$$\begin{matrix}[ Mathematical formula 8 ] & \\ {I}^{*} ( t ) = [ \begin{matrix}{I}_{1}^{*} ( t ) \\ {I}_{2}^{*} ( t ) \\ ⋮ \\ {I}_{M}^{*} ( t )\end{matrix} ] & ( 8 )\end{matrix}$$

M represents the number of modes. The value of any one of the elements I*₁(t) to I*_{M}(t) of the estimation mode vector I*(t) is 1, and the values of the other elements are 0.

The fact that the value of the element I*ᵢ(t) is 1 indicates the estimation result that the mode at the state prediction start time is the i-th mode.

In the case of indicating the distinction between the meta-modes, the estimation mode vector I*(t) can also be expressed as Formula (9).

$$\begin{matrix}[ Mathematical formula 9 ] & \\ {I}^{*} ( t ) = [ \begin{matrix}{I}_{1 , 1}^{*} ( t ) \\ ⋮ \\ {I}_{1 , \vert {J}_{1} \vert}^{*} ( t ) \\ ⋮ \\ {I}_{N , 1}^{*} ( t ) \\ ⋮ \\ {I}_{N , \vert {J}_{N} \vert}^{*} ( t )\end{matrix} ] & ( 9 )\end{matrix}$$

N indicates the number of meta-modes. |jⱼ| indicates the number of elements included in the j-th meta-mode. Here, j is an integer such that 1≤j≤N.

The fact that the value of the element I*_{j, i}(t) is 1 indicates the estimation result that the mode at the state prediction start time is the i-th mode of the j-th meta-mode.

FIG. 6 is a diagram illustrating an example of an estimation mode vector.

In the example of FIG. 6, M indicates the number of modes. The belief vector I\hat{ }(t) is a vector having M elements of real values.

The mode estimation unit 192 generates an estimation mode vector I*(t) with the value of one element having the largest value among the elements of the belief vector as 1 and the values of the other elements as 0. The estimation mode vector I*(t) can be regarded as a one-hot vector in which one mode estimated as the mode at the state prediction start time is indicated by an element value 1.

{0,1}^{M} indicates a binary M-dimensional space of 0 or 1. The estimation mode vector I*(t) is a one-hot vector in which the number of elements is M (the number of modes).

The state-related value calculation unit 193 may construct a continuous time model of the state of the state prediction target 910 using the estimation mode vector.

Here, if the mode vector I(t) can be obtained, a continuous time model as in Formula (10) can be constructed using a model for each mode.

$$\begin{matrix}[ Mathematical formula 10 ] & \\ \frac{d x ( t )}{d t} = {\sum }_{i = 1}^{M} {f}_{{θ}_{i}} ( x ( t ) , u ( t ) ) {I}_{i} ( t ) & ( 10 )\end{matrix}$$

f_{θi} is a function representing a model associated with the i-th mode. θᵢ represents a learning parameter of a function representing a model associated with the i-th mode (a parameter whose value is to be adjusted by learning). A model associated with the i-th mode is also referred to as an i-th model.

Hereinafter, the model provided for each mode is also referred to as a partial model, and the entire model obtained by combining the partial models is also referred to as an overall model.

Multiplying the output value of the partial model f_{θi} by the value of the element Iᵢ(t) of the mode vector I(t) in Formula (10) is equivalent to selecting the partial model of the mode of the estimation result indicated by the mode vector I(t) among the partial models for each mode. Therefore, in Formula (10), it can be understood that the partial model f_{θi} provided for each mode is switched and used according to the mode vector I(t).

The state-related value calculation unit 193 constructs a continuous time model as in Formula (11) by using the estimation mode vector I*(t) instead of the mode vector I(t).

$$\begin{matrix}[ Mathematical formula 11 ] & \\ \frac{dx ( t )}{d t} = {\sum }_{i = 1}^{M} {f}_{{θ}_{i}} ( x ( t ) , u ( t ) ) {I}_{i}^{*} ( t ) & ( 11 )\end{matrix}$$

In Formula (11), it can be understood that the state-related value calculation unit 193 switches and uses the partial model f_{θi} according to the estimation mode vector I*(t) instead of the mode vector I(t).

Alternatively, the mode estimation unit 192 may output the belief vector as an estimation result of the mode.

In this case, as in the example of FIG. 5, the mode estimation unit 192 may calculate the belief such that the total of the beliefs of the modes included in the meta-mode selected by the meta-mode determination unit 191 becomes 1. Then, the state-related value calculation unit 193 may calculate a value related to the state of the state prediction target 910 by using the belief vector as a weight vector for the output of the partial model provided for each mode.

For example, the state-related value calculation unit 193 constructs a continuous model of the state of the state prediction target 910 as in Formula (12) by using the belief vector I\hat{ }(t).

$$\begin{matrix}[ Mathematical formula 12 ] & \\ \frac{dx ( t )}{d t} = {\sum }_{i = 1}^{M} {f}_{{θ}_{i}} ( x ( t ) , u ( t ) ) {\hat{I}}_{i} ( t ) & ( 12 )\end{matrix}$$

In Formula (12), the state-related value calculation unit 193 weights and sums the output values of the partial model f_{θi} provided for each mode using the element Iᵢ\hat{ }(t) of the belief vector I\hat{ }(t) as a weight to calculate the time derivative dx(t)/dt of the state value x(t).

As described above, the state-related value calculation unit 193 calculates the value related to the state of the state prediction target 910 by using the belief vector as the weight vector, so that, for example, in a case where there are a plurality of elements having a relatively large value among the elements of the belief vector, the value can be calculated without the need to select any one mode (i.e., there is no need to pinpoint one mode). In this regard, the state-related value calculation unit 193 can stably calculate the value related to the state of the state prediction target 910.

That is, in a case where a value is calculated by selecting any one of a plurality of modes, it is conceivable that a difference in value (a difference in value between a case where the selected mode is correct and a case where the selected mode is incorrect) is large between a case where the selected mode is correct and a case where the selected mode is incorrect. On the other hand, it is expected that the state-related value calculation unit 193 or the mode estimation unit 192 can stably calculate the value in that there is no need to select any one mode.

In addition, since the belief of the mode included in the meta-mode other than the meta-mode selected by the meta-mode determination unit 191 is set to 0, it is expected that the state-related value calculation unit 193 can calculate the value related to the state of the state prediction target 910 with relatively high accuracy using the belief.

The mode estimation unit 192 may train the machine learning model used for the mode estimator using a statistical method. Training of the machine learning model may also be referred to as learning of the machine learning model.

As the training data, data in which a state sequence of a finite length and an input sequence are used as inputs to the machine learning model, and a one-hot vector indicating a true mode (mode at a state prediction start time with respect to the state sequence and input sequence provided as input) with an element value of 1 is used as correct answer data is used.

Here, the state sequence in the training data is expressed as X_{k-H}, X_{k-H+1}, . . . , xₖ. In addition, the input sequence in the training data is expressed as u_{k-H}, u_{k-H+1}, . . . , uₖ₋₁.

It is assumed that a subscript of x and a subscript of u(“k-H” etc.) indicate time steps, and that with a larger subscript value indicates newer data. Furthermore, H represents a length of data (the number of elements of data) and is an integer such that H ≥1.

Here, if a time length of one step in the time step is Δ, xₖ=x(kΔ), and uₖ=u(t), a relationship of kΔ≤t<(k+1)Δ is assumed. That is, it is assumed that the state changes from the state xₖ to the state xₖ₊₁ according to the input uₖ.

In addition, it is assumed that the mode estimator to be trained is a mode estimator of the j-th meta mode, and a partial vector Iⱼ(kΔ) of a mode vector I(kΔ) at a time kA is used as correct answer data.

The partial vector Iⱼ(k) used as the correct answer data is expressed by Formula (13).

$$\begin{matrix}[ Mathematical formula 13 ] & \\ {I}_{j} ( k Δ ) = [ \begin{matrix}{I}_{j , 1} ( k Δ ) \\ {I}_{j , 2} ( k Δ ) \\ ⋮ \\ {I}_{j , \vert {J}_{j} \vert} ( k Δ )\end{matrix} ] & ( 13 )\end{matrix}$$

The value of any one element from the element I_{j, 1} (kΔ) to I_{j, |Jj|}(kΔ) of the partial vector Iⱼ(kΔ) is 1, and the values of the other elements are 0.

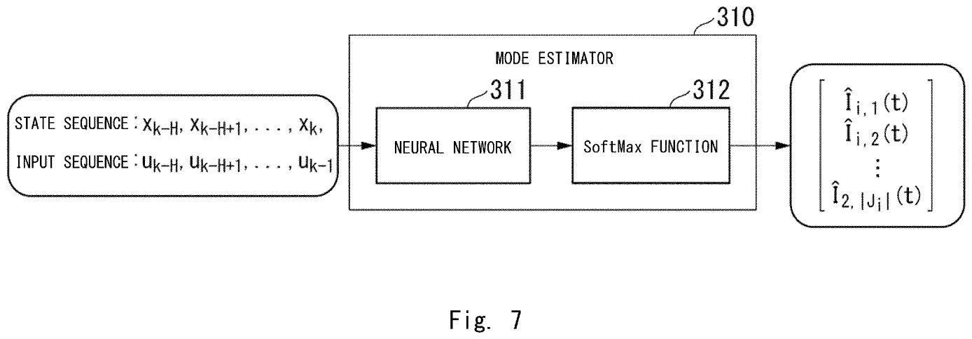

FIG. 7 is a diagram illustrating an example of a configuration of a mode estimator. In the example of FIG. 7, the mode estimator 310 includes a neural network 311 and a SoftMax function 312.

The neural network 311 corresponds to an example of a machine learning model used for the mode estimator. A feedforward type neural network may be used as the neural network 311, or a Recurrent Neural Network (RNN) may be used.

The SoftMax function 312 is provided to adjust the value of the belief such that the value of the belief for each mode is equal to or greater than 0 and the total of the beliefs is 1.

Adjusting the value of the belief such that the value of the belief for each mode is equal to or greater than 0 and the total of the beliefs is 1 is also referred to as normalization of the belief, or simply normalization.

Regarding the relationship with the determination result by the meta-mode determination unit 191, the mode estimator of the meta-mode selected by the meta-mode determination unit 191 may calculate the belief. Alternatively, the partial vector of the belief vector calculated by the mode estimator may be masked with the element value of the meta-mode vector. For example, the mode estimation unit 192 may multiply the partial vector of the belief vector calculated by the mode estimator by the element value of the meta-mode associated with the mode estimator among the element values of the meta-mode vector.

The mode estimation unit 192 may perform online adjustment of the belief of the mode output by the mode estimator by using an online state estimation algorithm such as Moving Horizon Estimation.

For example, the mode estimation unit 192 adjusts the belief value of each mode output by the mode estimator in such a way that the error between the prediction value of the state value and the actual value becomes as small as possible as shown in Formula (14).

$$\begin{matrix}[ Mathematical formula 14 ] & \\ {minimize}_{{z}_{i , 1} , … , {z}_{i , \vert {J}_{i} \vert}} {\sum }_{l = k - H}^{k} {‖ {x}_{l} - {\hat{x}}_{l} ‖}^{2} & ( 14 )\end{matrix}$$

x₁ represents a state value (measurement value) at time 1. x\hat{ }₁ represents a prediction value of the state value at time 1 by the state-related value calculation unit 193. It is assumed that the state-related value calculation unit 193 calculates the prediction value of the state value using the belief vector calculated by the mode estimation unit 192.

∥x₁−x₁∥² represents a square error between the state value x\hat{ }₁ and the prediction value x\hat{ }₁ of the state value by the estimated belief value of each mode and the prediction model of each mode.

His an integer such that H ≥1, indicating the length of the time-series data of the state value used for the online adjustment.

z_{i, 1}, . . . , z_{i, |ji|} represent a belief before normalization calculated by the mode estimation unit 192 for the meta-mode i selected by the meta-mode determination unit 191.

Formula (14) indicates adjusting the belief value before normalization in such a way as to obtain a belief such that the magnitude of the error between the time-series of the state value and the time-series of the prediction value of the state value by the prediction model becomes as small as possible.

The prediction value x\hat{ }₁ of the state value is expressed by Formula (15).

$$\begin{matrix}[ Mathematical formula 15 ] & \\ {\hat{x}}_{l} = ODESolver ( {\hat{x}}_{l - 1} , Δ , {\sum }_{j ∈ \{ 1 , 2 , … , \vert {J}_{i} \vert \}} \frac{exp ( {z}_{i ,} )}{{\sum }_{h ∈ \{ 1 , 2 , … , \vert {J}_{i} \vert \}} exp ( {z}_{i , h} )} {f}_{{θ}_{j}} ) ≅ {\hat{x}}_{l - 1} + Δ {\sum }_{j ∈ \{ 1 , 2 , … , \vert {J}_{i} \vert \}} \frac{exp ( {z}_{i ,} )}{{\sum }_{h ∈ \{ 1 , 2 , … , \vert {J}_{i} \vert \}} exp ( {z}_{i , h} )} {f}_{{θ}_{j}} ( {\hat{x}}_{l - 1} , {u}_{l - 1} ) & ( 15 )\end{matrix}$$

Formula (15) shows an example of a case in which the state-related value calculation unit 193 calculates the prediction value x\hat{ }ᵢ of the state value using a solver that uses an ordinary differential equation such as a neural ordinary differential equation.

f_{θj} is a function that is provided for each mode and indicates a model for calculating a time derivative value of a state value.

Σⱼ∈_{{1, 2, . . . , |Ji|}}((exp(z_{i, j})/(Σₕ ∈_{{1, 2, . . . , |Ji|}}exp(z_{i,j})))f_{θj}) indicates that the value of the time derivative of the state value calculated by the model is weighted and summed using the belief after the normalization as a weight.

0DESolver(x\hat{ }₁₋₁,Δ,Σⱼ∈_{{1, 2, . . . , |Ji|}}((exp(Σ_{i,j})/(Σₕ∈_{{1,2, . . . , |Ji|}}exp(z_{i,j})))f_{θj})) indicates calculating the change amount of the state value by numerically integrating the value of the time derivative of the state value weighted and summed using the belief with the time width Δ, adding the change amount to the prediction value x\hat{ }₁₋₁ of the state value at time 1-1, and calculating the prediction value x\hat{ }₁ of the state value at time 1.

The time width Δ indicates a sample time interval in the online adjustment.

ΔΣⱼ∈_{{1, 2, . . . , |Ji|}}((exp(z_{i, j})/(Σₕ∈_{{1, 2, . . . , |Ji|}}exp(z_{i, j})))f_{θj}(x\hat{ }₁₋₁, u₁₋₁)) indicates approximately calculating the change amount of the state value by multiplying the time width Δ by the value of the time derivative of the state value weighted and summed using the belief.

The length of the sample time interval Δ can be adjusted according to the calculation resource used for the online adjustment.

The mode estimation unit 192 may adjust the parameter value of the mode estimator online by using an online convex optimization algorithm. For example, for the sake of easy understanding of the description, it is considered to estimate the belief vector I\hat{ }ₖ at time k indicated in Formula (16) in a case where the number of meta-modes is one and discretization is performed by numerical integration.

$$\begin{matrix}[ Mathematical formula 16 ] & \\ {\hat{I}}_{k} = {[ {\hat{I}}_{1 \_ k} {\hat{I}}_{2 \_ k} … {\hat{I}}_{M \_ k} ]}^{T} ∈ {Δ}_{M} & ( 16 )\end{matrix}$$

A superscript T on a vector or matrix indicates transposition of the vector or matrix.

M represents the number of modes.

I\hat{ }_{i_k} indicates the belief of the i-th mode at time k. Here, i is an integer such that 1≤i≤M.

Δ_{M} represents an M-dimensional simplex that can be taken by the value of the belief vector I\hat{ }ₖ if discretized.

It is conceivable to use the loss l (I\hat{ }ₖ) expressed in Formula (17) as the loss for adjusting the belief by the mode estimator.

$$\begin{matrix}[ Mathematical formula 17 ] & \\ l ( {\hat{I}}_{k} ) = {‖ {x}_{k} - {\hat{x}}_{k} ‖}^{2} {‖ {x}_{k} - {\sum }_{j = 1}^{M} {f}_{j} ( {x}_{k - 1} , {u}_{k - 1} ) {\hat{I}}_{j , k} ‖}^{2} = {‖ {x}_{k} - {f ( {\hat{x}}_{k - 1} , {u}_{k - 1} )}^{T} {\hat{I}}_{k} ‖}^{2} & ( 17 )\end{matrix}$$

fⱼ is a model that calculates a prediction value of the state value associated with the j-th mode.

The function f(x, u) is expressed as Formula (18).

$$\begin{matrix}[ Mathematical formula 18 ] & \\ f ( x , u ) = [ \begin{matrix}{{f}_{1} ( x , u )}^{T} \\ {f}_{2} {( x , u )}^{T} \\ ⋮ \\ {f}_{M} {( x , u )}^{T}\end{matrix} ] & ( 18 )\end{matrix}$$

Here, ∥xₖ−f(xₖ₋₁, uₖ₋₁)^{T}I\hat{ }ₖ∥² is convex with respect to I\hat{ }ₖ∈Δ_{M}. Therefore, as an online adjustment algorithm that adjusts the belief estimated by the mode estimator, an online convex optimization algorithm such as Online Mirror Descent or Follow the Regularized Leader can be used.

In a case where the mode estimation unit 192 performs learning (training) of the mode estimator using a statistical method, there are advantages in that,
the output of the estimation result in a case where the mode is estimated using the mode estimator can be performed at high speed, and
compared with the case in which the belief output from the mode estimator is subjected to online adjustment, the belief value does not need to be periodically adjusted, and the calculation load is low in this respect.

On the other hand, in a case where the mode estimation unit 192 adjusts the parameter value of the mode estimator online, there are advantages in that,
prior learning of the mode estimator is unnecessary,
since prior learning is unnecessary, an event such as a decrease in estimation accuracy of a portion where training data is insufficient does not occur in comparison with a case where learning of the mode estimator is performed using a statistical method,
since prior learning is unnecessary, relearning of the mode estimator does not occur if the sample interval of the past time-series data is changed or if the model of each mode (neural ordinary differential equation etc.) is re-learned, and
change in behavior of the state prediction target 910, such as a change in setting of the state prediction target 910 can be flexibly handled.

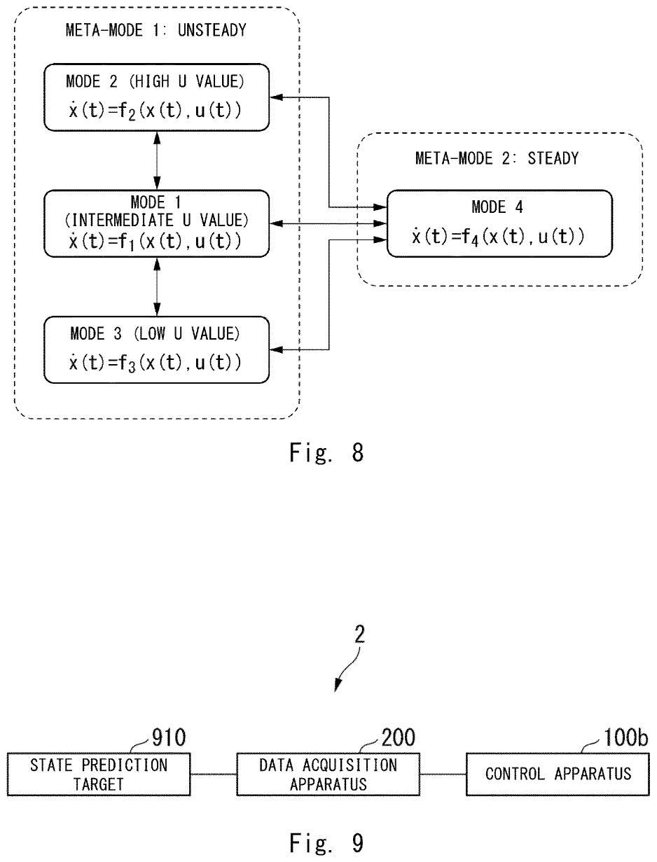

FIG. 8 is a diagram illustrating an example of an application scene of state prediction by the state prediction apparatus 100. FIG. 8 shows an example in a case where the product concentration is changed by distillation operation in a chemical plant or the like. It is conceivable that the plant makes an unsteady movement in a case where the product concentration is changed.

In the example of FIG. 8, the meta-mode 1 is a meta-mode if the plant is in an unsteady state. The meta-mode 2 is a meta-mode in a case where the plant is in a steady state.

Switching from the meta-mode 2 to the meta-mode 1 can be performed if an operation of changing the product concentration is performed or if the concentration greatly deviates from the target concentration due to disturbance.

In a case where the meta-mode determination unit 191 detects a large deviation from the target concentration, the meta-mode 2 may be switched to the meta-mode 1.

Furthermore, switching from the meta-mode 1 to the meta-mode 2 can be performed in response to the product concentration approaching the target concentration to some extent. It is conceivable that the behavior of the plant stabilizes in a case where the product concentration approaches the target concentration. In a case where the meta-mode determination unit 191 determines that the difference between the product concentration and the target concentration is equal to or smaller than the predetermined threshold value, the meta-mode 1 may be switched to the meta-mode 2.

In addition, if the plant is in an unsteady state, it is conceivable that the operation of the plant varies depending on the difference in U value (heat transfer coefficient of piping). It is considered that the U value changes due to disturbance such as heavy rain or heatwave.

In the example of FIG. 8, three modes of mode 2 that is a mode in which the U value is high, mode 3 that is a mode in which the U value is low, and mode 1 that is a mode in which the U value is an intermediate value are included in meta-mode 1.

Since the U value cannot be directly measured, the mode estimation unit 192 estimates the mode based on the state sequence and the input sequence.

In a case where the plant operates steadily, it is considered that the state transition of the plant can be simulated with a simple model as compared with a case where the plant operates unsteadily. Therefore, the model used in the mode (mode 4) of the meta-mode 2 may be a simpler model than the model used in the mode (modes 1, 2, and 3) of the meta-mode 1.

Furthermore, the state prediction apparatus 100 can also be applied even in a case where process parameters are discretized.

The neural ordinary differential equation including the process parameters can be expressed as Formula (19).

$$\begin{matrix}[ Mathematical formula 19 ] & \\ \dot{x} ( t ) = f ( x ( t ) , u ( t ) , p ( t ) ) & ( 19 )\end{matrix}$$

f is a function indicating a neural ordinary differential equation.

x(t) represents a state value of the state prediction target 910 at time t. x^{⋅}(t) represents a time derivative of the state value x(t).

u(t) represents an input to the state prediction target 910 at time t.

p(t) indicates a value of the process parameter at time t. The process parameter can be regarded as an internal parameter of the state prediction target 910 separately from the state x(t) and the input u(t). In a case where the value of the process parameter p(t) changes, the behavior of the state prediction target 910 changes.

It is preferable that the neural ordinary differential equation can be learned including the process parameter p(t), but if there is no large amount of data including various values of the process parameter p(t), it is difficult to perform training in such a way that the neural ordinary differential equation can perform estimation with high accuracy.

In a case where sufficient training data cannot be obtained from the state prediction target 910, it is conceivable to acquire training data by simulation, but in this case, time for performing simulation and calculation resource are required. For example, it is conceivable that simulation takes time.

Therefore, it is conceivable to discretize the process parameters. For example, a representative point of the process parameter value is determined based on the knowledge obtained for the state prediction target 910, and the process parameter is discretized at the representative point.

The neural ordinary differential equation in a case where the process parameters are discretized can be expressed as Formula (20).

$$\begin{matrix}[ Mathematical formula 20 ] & \\ \dot{x} ( t ) = f ( x ( t ) , u ( t ) ; p ) , p ∈ \{ {p}_{1} , {p}_{2} , … , {p}_{M} \} & ( 20 )\end{matrix}$$

It is conceivable to set the mode of state transition of the state prediction target 910 to each of the discrete values p₁, p₂, . . . , and p_{M} of the process parameters.

The neural ordinary differential equation using the belief is expressed as Formula (21).

$$\begin{matrix}[ Mathematical formula 21 ] & \\ \dot{x} ( t ) = {\sum }_{j = 1}^{M} f ( x ( t ) , u ( t ) ; {p}_{j} ) \hat{{I}_{j}} ( t ) & ( 21 )\end{matrix}$$

In the example of Formula (21), a model based on a neural ordinary differential equation is prepared for each discrete value of the process parameter p. I\hat{ }ⱼ(t) indicates the belief of the j-th mode at time t. In Formula (21), the time derivative value of the state value calculated by each model is weighted and summed using the belief I\hat{ }ⱼ(t) to calculate the time derivative value x(t) of the state value.

In addition, it is possible to narrow down mode candidates by creating a qualitative graph between modes. It is conceivable to set the meta-mode according to the narrowing down of the mode candidates.

The state prediction apparatus 100 may be configured as a control apparatus that performs control on the state prediction target 910.

FIG. 9 is a diagram illustrating an example of a configuration of the control system according to at least one example embodiment. In the configuration of FIG. 9, the control system 2 includes a control apparatus 100b and a data acquisition apparatus 200. In addition, FIG. 9 illustrates the state prediction target 910.

Of each of the units in FIG. 9, the portions having similar functions are denoted by the same reference numerals (200, 910) in correspondence with each of the units of FIG. 1, and a detailed description thereof will be omitted here. Comparing the configuration of the control system 2 with the configuration of the state prediction system 1, the control system 2 is different from the state prediction system 1 in that the control system 2 includes a control apparatus 100b instead of the state prediction apparatus 100 included in the state prediction system 1. Otherwise, the control system 2 is similar to the state prediction system 1.

The state prediction system 1 predicts a state of the state prediction target 910 and performs control on the state prediction target 910.

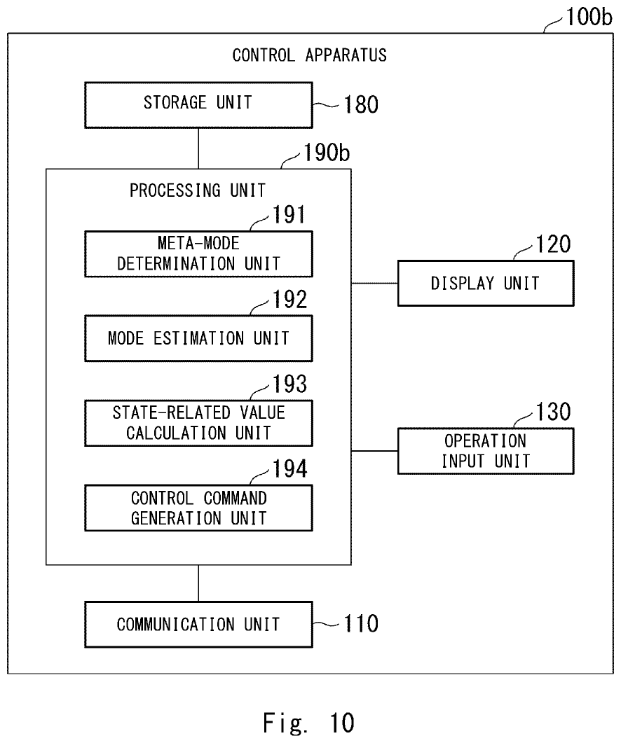

FIG. 10 is a diagram illustrating an example of a configuration of the control apparatus 100b. In the configuration illustrated in FIG. 10, the control apparatus 100b includes a communication unit 110, a display unit 120, an operation input unit 130, a storage unit 180, and a processing unit 190b. The processing unit 190b includes a meta-mode determination unit 191, a mode estimation unit 192, a state-related value calculation unit 193, and a control command generation unit 194.

Of each of the units in FIG. 10, the portions having similar functions are denoted by the same reference numerals (110, 120, 130, 180, 191, 192, 193) in correspondence with each of the units of FIG. 2, and a detailed description thereof will be omitted here.

The control apparatus 100b is different from the state prediction apparatus 100 in that the processing unit 190b further includes a control command generation unit 194 in addition to each unit included in the processing unit 190 of the state prediction apparatus 100. Otherwise, the control apparatus 100b is similar to the state prediction apparatus 100.

The control command generation unit 194 generates a control command for the state prediction target 910 by using the value related to the state of the state prediction target 910 calculated by the state-related value calculation unit 193. Then, the control command generation unit 194 transmits the generated control command to the state prediction target 910 via the communication unit 110. As a result, the control apparatus 100b controls the state prediction target 910.

For example, the state-related value calculation unit 193 may predict the state value. Then, the control command generation unit 194 may generate the control command by optimal control for reducing the magnitude of the error as much as possible by using an evaluation function indicating the magnitude of the error between the prediction value of the state value and the plan value.

However, the method by which the control command generation unit 194 generates a control command is not limited to a specific method, and various methods using values related to the state of the state prediction target 910 calculated by the state-related value calculation unit 193 can be used.

The state prediction target 910 to be controlled by the control apparatus 100b is not limited to a specific one, and may be various ones whose state changes according to a control command. As described above for the state prediction apparatus 100, the state prediction target 910 may be a device such as a machine tool, a robot, or a moving body (e.g., a vehicle, a drone, or the like). Alternatively, the state prediction target 910 may be a system including a plurality of machines, such as a chemical plant, a factory such as an iron manufacturing plant or a machine manufacturing factory, a production line in a factory, or a power plant. Alternatively, the state prediction target 910 may be a natural environment of a scale the state can be controlled, such as the atmosphere, a river, or soil.

For example, in a case where the state prediction target 910 is some kind of production plant such as a chemical plant or a steel plant, various measurable values such as a flow rate, a pressure, a temperature, a concentration, or a water level of a substance in the plant can be used as the state value of the state prediction target 910.

In addition, for example, in a case where the operation of the plant is stabilized at a predetermined concentration or temperature, the control apparatus 100b may transmit a control command for adjusting the concentration or temperature in such a way as to stabilize the operation of the plant to the state prediction target 910.

In addition, the control apparatus 100b may control the transition period of the state of the plant, such as transmitting a control command to improve the efficiency of the pressure increase at the start of the operation of the plant.

In these examples, the meta-mode may be set such that a case where the state of the plant is steady and a case where the state of the plant is unsteady are distinguished by the meta-mode.

Regarding the setting of the meta-mode and the mode, it is conceivable to set the mode by a range of a state value of the state prediction target 910 (control target), a range of a control input value, or a range of a process parameter value, or a combination thereof. Then, it is conceivable to set the meta-mode such that the meta-mode is also switched by switching detectable by a sensor, a control command, or the like of the switching of the modes.

For example, in a case where a large chemical change occurs if the temperature in the plant is equal to or higher than 100° C. and the temperature can be measured, it is conceivable to set the meta-mode such that the meta-mode is switched depending on whether the temperature is equal to or higher than 100° C.

In addition, in a case where the switch of the device in which the inflow amount of water into a certain portion in the plant is 1 cubic meter (1 m³/h) per hour or more is turned on and the inflow amount can be measured, it is conceivable to set the meta-mode such that the meta-mode is switched depending on whether the inflow amount of water is 1 cubic meter per hour or more.

In addition, in a case where the valve is fully opened and the flow rate is greatly changed if the drum water level in the plant is equal to or greater than 50 centimeters (50 cm), and the drum water level can be measured, it is conceivable to set the meta-mode such that the meta-mode is switched depending on whether the drum water level is equal to or greater than 50 centimeters.

On the other hand, in a case where the heat transfer coefficient of the pipe greatly changes due to disturbance such as weather and the reaction rate in the plant changes, the heat transfer coefficient is a theoretical value and cannot be directly measured by the sensor. In this case, as in the example of FIG. 8, it is conceivable to divide the mode in the meta-mode in such a way that the mode is switched by the change in the heat transfer coefficient.

As described above, the meta-mode determination unit 191 selects some of the modes assumed as the mode of state transition of the state prediction target 910 as the candidate of the mode of state transition of the state prediction target at the state prediction start time based on the state data indicating the state of the state prediction target 910 at the time before the state prediction start time and the input data indicating the input to the state prediction target 910 at the time before the state prediction start time.

The mode estimation unit 192 estimates the mode of state transition of the state prediction target 910 at the state prediction start time based on the selected candidate of the mode of state transition of the state prediction target 910 at the state prediction start time, the state data, and the input data.

According to the state prediction apparatus 100, it is expected that the state of the state prediction target 910 can be predicted with relatively high accuracy even in a case where the mode cannot be uniquely specified in terms of selecting a candidate of the mode based on the state data and the input data.

For example, in a case where the state prediction apparatus 100 estimates the belief of the mode as the hidden internal state estimation, it is expected that the belief of the mode included in the selected meta-mode can be estimated with relatively high accuracy in that the belief of the mode included in the meta-mode other than the selected meta-mode is estimated as 0.

Furthermore, in a case where the state prediction apparatus 100 estimates a mode as the hidden internal state estimation, it is expected that the mode can be estimated with relatively high accuracy in that the mode can be prevented from being estimated as a mode included in a meta-mode other than the selected meta-mode.

Furthermore, in a case where the state prediction apparatus 100 predicts the state value based on the belief of the mode, it is expected that the state value can be predicted with relatively high accuracy in that the prediction value of the state value can be calculated by excluding the mode included in the meta-mode other than the selected meta-mode from the calculation target.

Furthermore, in a case where the state prediction apparatus 100 estimates a mode and predicts a state value based on the estimated mode, it is expected that the state value can be predicted with relatively high accuracy in that the mode can be prevented from being estimated as a mode included in a meta-mode other than the selected meta-mode.

Furthermore, the state-related value calculation unit 193 calculates a value related to the state of the state prediction target 910 based on the estimation result of the mode by the mode estimation unit 192 by using the prediction model provided for each mode.

According to the state prediction apparatus 100, a prediction model according to the complexity of the behavior of the state prediction target 910 in each mode can be used. For example, a prediction model that is relatively complex may be used in a mode in which the behavior of the state prediction target 910 is complex, and a prediction model that is relatively simple may be used in a mode in which the behavior of the state prediction target 910 is simple. As a result, it is expected that calculation can be performed with relatively high accuracy with a model of a relatively small scale for the entire model used for calculation of a value related to the state of the state prediction target 910.

Furthermore, according to the state prediction apparatus 100, it is expected that the value related to the state of the state prediction target 910 can be calculated with relatively high accuracy in that the value related to the state of the state prediction target 910 is calculated in consideration of the determination result of the meta-mode by the meta-mode determination unit.

Furthermore, the mode estimation unit 192 selects one of the mode candidates in the mode estimation.

The state-related value calculation unit 193 calculates a value related to the state of the state prediction target 910 by using the prediction model associated with the selected mode.

According to the state prediction apparatus 100, the load of the state-related value calculation unit 193 is small in that the state-related value calculation unit 193 calculates a value related to the state of the state prediction target 910 by using one prediction model associated with the selected mode.

Furthermore, the mode estimation unit 192 calculates, for each mode candidate, a belief (likelihood) that the mode of state transition of the state prediction target 910 is the mode.

The state-related value calculation unit 193 calculates, as a value related to the state of the state prediction target 910, a value obtained by weighting and summing the output values of the prediction models associated with each of the mode candidates by the weight based on the belief calculated by the mode estimation unit.

According to the state prediction apparatus 100, a value related to the state of the state prediction target 910 can be stably calculated in that it is not necessary to select (pinpoint) any one mode.

Furthermore, according to the state prediction apparatus 100, it is expected that the value related to the state of the state prediction target 910 can be calculated with relatively high accuracy in that the belief of the mode included in the meta-mode other than the meta-mode selected by the meta-mode determination unit 191 is set to 0.

In addition, the prediction model used by the state-related value calculation unit 193 is a machine learning model trained using state data indicating the state of the state prediction target 910 and input data indicating an input to the state prediction target 910.

According to the state prediction apparatus 100, since the machine learning model is provided for each mode, it is possible to prevent the accuracy of the machine learning model (prediction accuracy by the machine learning model) from deteriorating for other modes due to the training of the machine learning model for a certain mode.

According to the state prediction apparatus 100, in this respect, the training of the machine learning model can be performed with high accuracy, and the value related to the state of the state prediction target 910 can be calculated with relatively high accuracy by using the machine learning model.

In addition, the mode estimation unit 192 inputs, to a machine learning model trained using training data having time-series data of the state of the state prediction target 910 and time-series data of the input to the state prediction target 910 as input data to a machine learning model, and one-hot vector having an element for each mode candidate and indicating a correct answer mode as correct answer data, the time-series data of the state of the state prediction target 910 and the time-series data of the input to the state prediction target 910, and outputs a value obtained by normalizing a value output by the machine learning model for each mode candidate such that an output value associated with any candidate is equal to or greater than 0 and a value obtained by summing the output values for all the candidates is 1 as an estimation result of the mode.

According to the state prediction apparatus 100, the value related to the state of the state prediction target 910 can be calculated by weighting and summing the value related to the state of the state prediction target 910 calculated for each mode by using the normalized value as the weighting coefficient.

In addition, the mode estimation unit 192 adjusts the belief value of each mode for estimating the mode of state transition of the state prediction target 910 such that the magnitude of the error between the prediction value of the state of the state prediction target 910 predicted by the belief value of each mode and the prediction model of each mode, and the state of the state prediction target 910 becomes smaller by using the online state estimation algorithm or the online convex optimization algorithm.

According to the state prediction apparatus 100, the prior learning of the machine learning model is unnecessary by performing online adjustment on the belief value of each mode.

In addition, according to the state prediction apparatus 100, since the prior learning of the machine learning model is unnecessary, there is no event that the estimation accuracy of the portion in which the training data is insufficient is decreased in comparison with the case where training the machine learning model is performed using the statistical method.

Furthermore, according to the state prediction apparatus 100, since the prior learning of the machine learning model is unnecessary, relearning of the mode estimator does not occur in a case where the prediction model (neural ordinary differential equation etc.) of each mode is relearned, such as a case where the sample interval of the past time-series data is changed.

Furthermore, according to the state prediction apparatus 100, it is possible to flexibly respond to a change in behavior of the state prediction target 910, such as a change in setting of the state prediction target 910.

### Second Example Embodiment

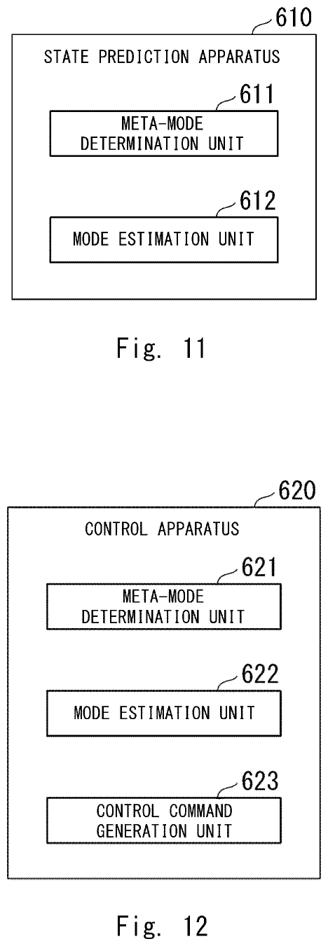

FIG. 11 is a diagram illustrating an example of a configuration of a state prediction apparatus according to at least one example embodiment. In the configuration illustrated in FIG. 11, the state prediction apparatus 610 includes a meta-mode determination unit 611 and a mode estimation unit 612.

In such a configuration, the meta-mode determination unit 611 selects some of the modes assumed as the mode of state transition of the state prediction target as the candidates of the mode of state transition of the state prediction target at the state prediction start time based on the state data indicating the state of the state prediction target at the time before the state prediction start time and the input data indicating the input to the state prediction target at the time before the state prediction start time.

The mode estimation unit 612 estimates the mode of state transition of the state prediction target at the state prediction start time based on the selected candidate of the mode of state transition of the state prediction target at the state prediction start time, the state data, and the input data.

The meta-mode determination unit 611 corresponds to an example of a meta-mode determination means. The mode estimation unit 612 corresponds to an example of a mode estimation means.

According to the state prediction apparatus 610, it is expected that the state of the state prediction target can be predicted with relatively high accuracy even in a case where the mode cannot be uniquely specified in that a mode candidate is selected based on the state data and the input data.

For example, in a case where the state prediction apparatus 610 estimates the belief of the mode as the hidden internal state estimation, the belief of the mode included in the meta-mode other than the selected meta-mode can be estimated as 0. According to the state prediction apparatus 610, in this respect, it is expected that the belief of the mode included in the selected meta-mode can be estimated with relatively high accuracy.

Furthermore, in a case where the state prediction apparatus 610 estimates a mode as the hidden internal state estimation, it is expected that the mode can be estimated with relatively high accuracy in that the mode can be prevented from being estimated as a mode included in a meta-mode other than the selected meta-mode.

Furthermore, in a case where the state prediction apparatus 610 predicts the state value based on the belief of the mode, the prediction value of the state value can be calculated by excluding the mode included in the meta-mode other than the selected meta-mode from the target of calculation. According to the state prediction apparatus 610, in this respect, it is expected that the state value can be predicted with relatively high accuracy.

Furthermore, in a case where the state prediction apparatus 610 estimates a mode and predicts a state value based on the estimated mode, it is expected that the state value can be predicted with relatively high accuracy in that the mode can be prevented from being estimated as a mode included in a meta-mode other than the selected meta-mode.

The meta-mode determination unit 611 can be achieved by using, for example, functions of the meta-mode determination unit 191 and the like in FIG. 2. The mode estimation unit 612 can be achieved by using, for example, functions of the mode estimation unit 192 and the like in FIG. 2.

### Third Example Embodiment

FIG. 12 is a diagram illustrating an example of a configuration of a control apparatus according to at least one example embodiment. In the configuration illustrated in FIG. 12, the control apparatus 620 includes a meta-mode determination unit 621, a mode estimation unit 622, and a control command generation unit 623.

In such a configuration, the meta-mode determination unit 621 selects some of the modes assumed as the mode of state transition of the state prediction target as the candidates of the mode of state transition of the state prediction target at the state prediction start time based on the state data indicating the state of the state prediction target at the time before the state prediction start time and the input data indicating the input to the state prediction target at the time before the state prediction start time.

The mode estimation unit 622 estimates the mode of state transition of the state prediction target at the state prediction start time based on the selected candidate of the mode of state transition of the state prediction target at the state prediction start time, the state data, and the input data.

The control command generation unit 623 generates a control command with respect to the state prediction target based on the estimation result of the mode.

The meta-mode determination unit 621 corresponds to an example of a meta-mode determination means. The mode estimation unit 622 corresponds to an example of a mode estimation means. The control command generation unit 623 corresponds to an example of a control command generation means.

According to the control apparatus 620, it is expected that the state of the state prediction target can be predicted with relatively high accuracy even in a case where the mode cannot be uniquely specified in that a mode candidate is selected based on the state data and the input data. According to the control apparatus 620, in this respect, it is expected that the state prediction target can be controlled with relatively high accuracy using the state prediction result.

Regarding the mode estimation, for example, in a case where the control apparatus 620 estimates the belief of the mode as the hidden internal state estimation, the belief of the mode included in the meta-mode other than the selected meta-mode can be estimated as 0. According to the control apparatus 620, in this respect, it is expected that the belief of the mode included in the selected meta-mode can be estimated with relatively high accuracy.

Furthermore, in a case where the control apparatus 620 estimates a mode as the hidden internal state estimation, it is expected that the mode can be estimated with relatively high accuracy in that the mode can be prevented from being estimated as a mode included in a meta-mode other than the selected meta-mode.

Furthermore, in a case where the control apparatus 620 predicts the state value based on the belief of the mode, the prediction value of the state value can be calculated by excluding the mode included in the meta-mode other than the selected meta-mode from the target of calculation. According to the control apparatus 620, in this respect, it is expected that the state value can be predicted with relatively high accuracy.

Furthermore, in a case where the control apparatus 620 estimates a mode and predicts a state value based on the estimated mode, it is expected that the state value can be predicted with relatively high accuracy in that the mode can be prevented from being estimated as a mode included in a meta-mode other than the selected meta-mode.

The meta-mode determination unit 611 can be achieved by using, for example, functions of the meta-mode determination unit 191 and the like in FIG. 10. The mode estimation unit 612 can be achieved by using, for example, functions of the mode estimation unit 192 and the like in FIG. 10. The control command generation unit 623 can be achieved by using, for example, functions of the control command generation unit 194 and the like in FIG. 10.

### Fourth Example Embodiment

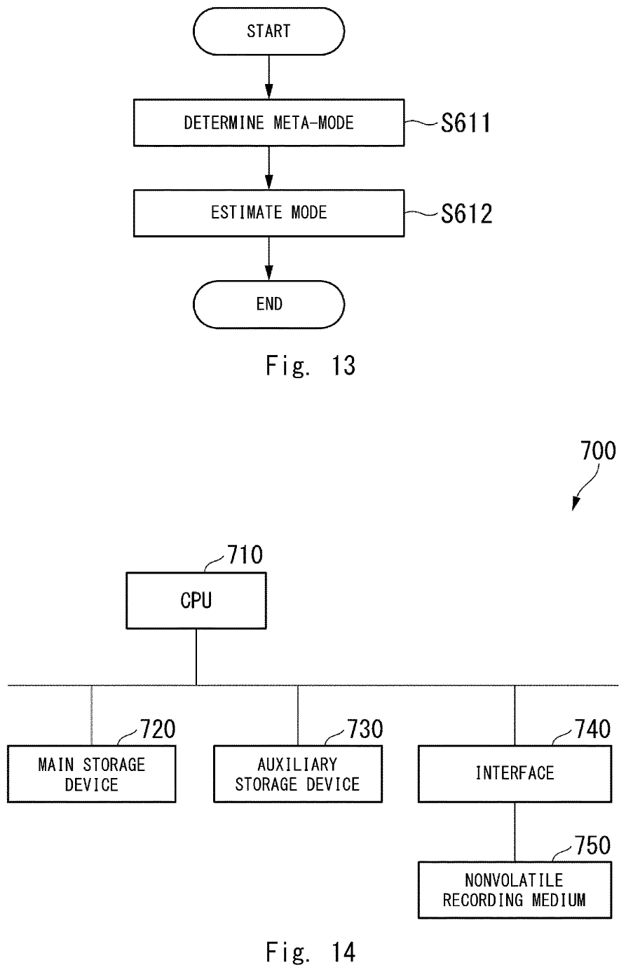

FIG. 13 is a diagram illustrating an example of a procedure of processing in a state prediction method according to at least one example embodiment. The state prediction method illustrated in FIG. 13 includes determining a meta-mode (step S611) and estimating the mode (step S612).

In estimating the meta-mode (step S611), the computer selects some of the modes assumed as the mode of state transition of the state prediction target as the candidates of the mode of state transition of the state prediction target at the state prediction start time based on the state data indicating the state of the state prediction target at the time before the state prediction start time and the input data indicating the input to the state prediction target at the time before the state prediction start time.

In estimating the mode (step S612), the computer estimates the mode of state transition of the state prediction target at the state prediction start time based on the selected candidate of the mode of state transition of the state prediction target at the state prediction start time, the state data, and the input data.

According to the state prediction method illustrated in FIG. 13, it is expected that the state of the state prediction target can be predicted with relatively high accuracy even in a case where the mode cannot be uniquely specified in that a mode candidate is selected based on the state data and the input data.

For example, in a case where the belief of the mode is estimated as the hidden internal state estimation by the state prediction method illustrated in FIG. 13, the belief of the mode included in the meta-mode other than the selected meta-mode can be estimated as 0. According to the state prediction method illustrated in FIG. 13, in this respect, it is expected that the belief of the mode included in the selected meta-mode can be estimated with relatively high accuracy.

Furthermore, in a case where a mode is estimated as the hidden internal state estimation by the state prediction method illustrated in FIG. 13, it is expected that the mode can be estimated with relatively high accuracy in that the mode can be prevented being estimated as a mode included in a meta-mode other than the selected meta-mode.

In the case where the state value is predicted based on the belief of the mode by the state prediction method in FIG. 13, the prediction value of the state value can be calculated by excluding modes included in meta-modes other than the selected meta-mode from the target of calculation. According to the state prediction method illustrated in FIG. 13, in this respect, it is expected that the state value can be predicted with relatively high accuracy.

Furthermore, in a case where the mode is estimated by the state prediction method illustrated in FIG. 13 and the state value is predicted based on the estimated mode, it is expected that the state value can be predicted with relatively high accuracy in that the mode can be prevented from being estimated as a mode included in a meta-mode other than the selected meta-mode.

FIG. 14 is a diagram illustrating an example of a configuration of a computer according to at least one example embodiment.

In the configuration illustrated in FIG. 14, a computer 700 includes a CPU 710, a main storage device 720, an auxiliary storage device 730, an interface 740, and a nonvolatile recording medium 750.

Any one or more of the state prediction apparatus 100, the control apparatus 100b, the state prediction apparatus 610, and the control apparatus 620 described above or a part thereof may be implemented in the computer 700. In this case, the operation of each processing unit described above is stored in the auxiliary storage device 730 in the form of a program. The CPU 710 reads the program from the auxiliary storage device 730, loads the program in the main storage device 720, and executes the above processing according to the program. The CPU 710 secures a storage area related to each of the above-described storage units in the main storage device 720 according to the program. Communication between each device and another device is executed by the interface 740 having a communication function performing communication according to the control of the CPU 710. The interface 740 has a port for the nonvolatile recording medium 750, and reads information from the nonvolatile recording medium 750 and writes information to the nonvolatile recording medium 750.

In a case where the state prediction apparatus 100 is implemented in the computer 700, the operation of the processing unit 190 and each unit thereof is stored in the auxiliary storage device 730 in the form of a program. The CPU 710 reads the program from the auxiliary storage device 730, loads the program in the main storage device 720, and executes the above processing according to the program.

The CPU 710 secures a storage area for the storage unit 180 in the main storage device 720 according to the program. Communication with another device by the communication unit 110 is executed by the interface 740 having a communication function operating according to the control of the CPU 710. The display of the image by the display unit 120 is executed by the interface 740 including a display device and displaying various images under the control of the CPU 710. The acceptance of user operation by the operation input unit 130 is executed by the interface 740 including an input device and accepting the user operation under the control of the CPU 710.

In a case where the control apparatus 100b is implemented in the computer 700, the operation of the processing unit 190b and each unit thereof are stored in the auxiliary storage device 730 in the form of a program. The CPU 710 reads the program from the auxiliary storage device 730, loads the program in the main storage device 720, and executes the above processing according to the program.

The CPU 710 secures a storage area for the storage unit 180 in the main storage device 720 according to the program. Communication with another device by the communication unit 110 is executed by the interface 740 having a communication function operating according to the control of the CPU 710. The display of the image by the display unit 120 is executed by the interface 740 including a display device and displaying various images under the control of the CPU 710. The acceptance of user operation by the operation input unit 130 is executed by the interface 740 including an input device and accepting the user operation under the control of the CPU 710.

In a case where the state prediction apparatus 610 is implemented in the computer 700, the operations of the meta-mode determination unit 611 and the mode estimation unit 612 are stored in the auxiliary storage device 730 in the form of a program. The CPU 710 reads the program from the auxiliary storage device 730, loads the program in the main storage device 720, and executes the above processing according to the program.

In addition, the CPU 710 secures a storage area for the state prediction apparatus 610 to perform processing in the main storage device 720 according to the program. Communication between the state prediction apparatus 610 and another device is executed by the interface 740 having a communication function operating according to the control of the CPU 710. The interaction between the state prediction apparatus 610 and the user is executed by the interface 740 including an input device and an output device, in which information is presented to the user by the output device according to the control of the CPU 710 and user operation is accepted by the input device.

In a case where the control apparatus 620 is implemented in the computer 700, the operations of the meta-mode determination unit 621, the mode estimation unit 622 and the control command generation unit 623 are stored in the auxiliary storage device 730 in the form of a program. The CPU 710 reads the program from the auxiliary storage device 730, loads the program in the main storage device 720, and executes the above processing according to the program.

The CPU 710 secures a storage area for the control apparatus 620 to perform processing in the main storage device 720 according to the program. Communication between the control apparatus 620 and another device is executed by the interface 740 having a communication function operating according to the control of the CPU 710. The interaction between the control apparatus 620 and the user is executed by the interface 740 including an input device and an output device, in which information is presented to the user by the output device according to the control of the CPU 710 and user operation is accepted by the input device.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily save the program in the main storage device 720 or the auxiliary storage device 730 and execute the program.

A program for executing all or part of the processing performed by the state prediction apparatus 100, the control apparatus 100b, the state prediction apparatus 610, and the control apparatus 620 may be recorded in a computer-readable recording medium, and the processing of each unit may be performed by causing a computer system to read and execute the program recorded in the recording medium. The “computer system” herein includes an Operating System (OS) and hardware such as peripheral devices.

Furthermore, the “computer-readable recording medium” refers to a portable medium such as a flexible disk, a magneto-optical disk, a Read Only Memory (ROM), and a Compact Disc Read Only Memory (CD-ROM), and a storage device such as a hard disk built in a computer system. The program may be for achieving some of the functions described above, and the functions described above may be achieved in combination with a program already recorded in the computer system.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The above-described example embodiments can be appropriately combined with other example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments may be described as the following Supplementary Notes, but are not limited to the following.

### Supplementary Note 1

A state prediction apparatus including a meta-mode determination means for selecting some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and a mode estimation means for estimating a mode of state transition of the state prediction target at the state prediction start time based on a selected candidate of the mode of state transition of the state prediction target at the state prediction start time, the state data, and the input data.

### Supplementary Note 2

The state prediction apparatus according to supplementary note 1, further including a state-related value calculation means for calculating a value related to a state of the state prediction target based on an estimation result of the mode by using a prediction model provided for each mode.

### Supplementary Note 3

The state prediction apparatus according to supplementary note 2, in which
the mode estimation means selects one of the modes among the mode candidates in the estimation of the mode, and
the state-related value calculation means calculates a value related to the state of the state prediction target by using the prediction model associated with the selected mode.

### Supplementary Note 4

The state prediction apparatus according to supplementary note 2, in which
the mode estimation means calculates, for each of the mode candidates, a belief that a mode of state transition of the state prediction target is the mode, and
the state-related value calculation means calculates, as a value related to the state of the state prediction target, a value obtained by weighting and summing output values of the prediction models associated with each of the mode candidates by a weight based on the belief.

### Supplementary Note 5

The state prediction apparatus according to any one of supplementary notes 2 to 4, in which the prediction model is a machine learning model trained using state data indicating a state of the state prediction target and input data indicating an input to the state prediction target.

### Supplementary Note 6

The state prediction apparatus according to any one of supplementary notes 2 to 5, in which the mode estimation means inputs, to a machine learning model trained using training data having time-series data of the state of the state prediction target and time-series data of the input to the state prediction target as input data to a machine learning model, and one-hot vector having an element for each mode candidate and indicating a correct answer mode as correct answer data, the time-series data of the state of the state prediction target and the time-series data of the input to the state prediction target, and outputs a value obtained by normalizing a value output by the machine learning model for each mode candidate such that an output value associated with any candidate is equal to or greater than 0 and a value obtained by summing the output values for all the candidates is 1 as an estimation result of the mode.

### Supplementary Note 7

The state prediction apparatus according to any one of supplementary notes 2 to 5, in which the mode estimation means adjusts a belief value of each mode for estimating a mode of state transition of the state prediction target such that a magnitude of an error between a prediction value of the state of the state prediction target predicted by a belief value of each mode and a prediction model of each mode, and the state of the state prediction target becomes smaller by using an online state estimation algorithm or an online convex optimization algorithm.

### Supplementary Note 8

A control apparatus including
a meta-mode determination means for selecting some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time,
a mode estimation means for estimating a mode of state transition of the state prediction target at the state prediction start time based on a selected candidate of the mode of state transition of the state prediction target at the state prediction start time, the state data, and the input data, and
a control command generation means for generating a control command with respect to the state prediction target based on an estimation result of the mode.

### Supplementary Note 9

The control apparatus according to supplementary note 8, further including a state-related value calculation means for calculating a value related to a state of the state prediction target based on an estimation result of the mode by using a prediction model provided for each mode.

### Supplementary Note 10

The control apparatus according to supplementary note 9, in which
the mode estimation means selects one of the modes among the mode candidates in the estimation of the mode, and
the state-related value calculation means calculates a value related to the state of the state prediction target by using the prediction model associated with the selected mode.

### Supplementary Note 11

The control apparatus according to supplementary note 9, in which
the mode estimation means calculates, for each of the mode candidates, a belief that a mode of state transition of the state prediction target is the mode, and
the state-related value calculation means calculates, as a value related to the state of the state prediction target, a value obtained by weighting and summing output values of the prediction models associated with each of the mode candidates by a weight based on the belief.

### Supplementary Note 12

The control apparatus according to any one of supplementary notes 9 to 11, in which the prediction model is a machine learning model trained using state data indicating a state of the state prediction target and input data indicating an input to the state prediction target.

### Supplementary Note 13

The control apparatus according to any one of supplementary notes 9 to 12, in which the mode estimation means inputs, to a machine learning model trained using training data having time-series data of the state of the state prediction target and time-series data of the input to the state prediction target as input data to a machine learning model, and one-hot vector having an element for each mode candidate and indicating a correct answer mode as correct answer data, the time-series data of the state of the state prediction target and the time-series data of the input to the state prediction target, and outputs a value obtained by normalizing a value output by the machine learning model for each mode candidate such that an output value associated with any candidate is equal to or greater than 0 and a value obtained by summing the output values for all the candidates is 1 as an estimation result of the mode.

### Supplementary Note 14

The control apparatus according to any one of supplementary notes 9 to 12, in which the mode estimation means adjusts a belief value of each mode for estimating a mode of state transition of the state prediction target such that a magnitude of an error between a prediction value of the state of the state prediction target predicted by belief value of each mode and a prediction model of each mode, and the state of the state prediction target becomes smaller by using an online state estimation algorithm or an online convex optimization algorithm.

### Supplementary Note 15

A state prediction method including having a computer to
select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and
estimate a mode of state transition of the state prediction target at the state prediction start time based on a selected candidate of the mode of state transition of the state prediction target at the state prediction start time, the state data, and the input data.

### Supplementary Note 16

The state prediction method according to supplementary note 15, further including having a computer to calculate a value related to a state of the state prediction target based on an estimation result of the mode by using a prediction model provided for each mode.

### Supplementary Note 17

The state prediction method according to supplementary note 16, in which
estimating the mode includes the computer to select any one of the modes among the mode candidates in the estimation of the mode, and
calculating a value related to the state of the state prediction target includes the computer to calculate a value related to the state of the state prediction target by using the prediction model associated with the selected mode.

### Supplementary Note 18

The state prediction method according to supplementary note 16, in which
estimating the mode includes the computer to calculate, for each of the mode candidates, a belief that a mode of state transition of the state prediction target is the mode, and
calculating a value related to the state of the state prediction target includes the computer to calculate, as a value related to the state of the state prediction target, a value obtained by weighting and summing output values of the prediction models associated with each of the mode candidates by a weight based on the belief.

### Supplementary Note 19

The state prediction method according to any one of supplementary notes 16 to 18, in which the prediction model is a machine learning model trained using state data indicating a state of the state prediction target and input data indicating an input to the state prediction target.

### Supplementary Note 20

The state prediction method according to any one of supplementary notes 16 to 19, in which estimating the mode includes the computer to input, to a machine learning model trained using training data having time-series data of the state of the state prediction target and time-series data of the input to the state prediction target as input data to a machine learning model, and one-hot vector having an element for each mode candidate and indicating a correct answer mode as correct answer data, the time-series data of the state of the state prediction target and the time-series data of the input to the state prediction target, and output a value obtained by normalizing a value output by the machine learning model for each mode candidate such that an output value associated with any candidate is equal to or greater than 0 and a value obtained by summing the output values for all the candidates is 1 as an estimation result of the mode.

### Supplementary Note 21

The state prediction method according to any one of supplementary notes 16 to 19, in which estimating the mode includes the computer to adjust a belief value of each mode for estimating a mode of state transition of the state prediction target such that a magnitude of an error between a prediction value of the state of the state prediction target predicted by a belief value of each mode and a prediction model of each mode, and the state of the state prediction target becomes smaller by using an online state estimation algorithm or an online convex optimization algorithm.

### Supplementary Note 22

A program for causing a computer to
select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time, and
estimate a mode of state transition of the state prediction target at the state prediction start time based on a selected candidate of the mode of state transition of the state prediction target at the state prediction start time, the state data, and the input data.

### Supplementary Note 23

The program according to supplementary note 22, further causing the computer to calculate a value related to a state of the state prediction target based on an estimation result of the mode by using a prediction model provided for each mode.

### Supplementary Note 24

The program according to supplementary note 23, in which
in estimating the mode, the computer is caused to execute selecting any one of the modes among the mode candidates in the estimation of the mode, and
in calculating a value related to the state of the state prediction target, the computer is caused to execute calculating a value related to the state of the state prediction target by using the prediction model associated with the selected mode.

### Supplementary Note 25

The program according to supplementary note 23, in which
in estimating the mode, the computer is caused to execute calculating, for each of the mode candidates, a belief that a mode of state transition of the state prediction target is the mode, and
in calculating a value related to the state of the state prediction target, the computer is caused to execute calculating, as a value related to the state of the state prediction target, a value obtained by weighting and summing output values of the prediction models associated with each of the mode candidates by a weight based on the belief.

### Supplementary Note 26

The program according to any one of supplementary notes 23 to 25, in which the prediction model is a machine learning model trained using state data indicating a state of the state prediction target and input data indicating an input to the state prediction target.

### Supplementary Note 27

The program according to any one of supplementary notes 23 to 26, in which in estimating the mode, the computer is caused to execute inputting, to a machine learning model trained using training data having time-series data of the state of the state prediction target and time-series data of the input to the state prediction target as input data to a machine learning model, and one-hot vector having an element for each mode candidate and indicating a correct answer mode as correct answer data, the time-series data of the state of the state prediction target and the time-series data of the input to the state prediction target, and outputting a value obtained by normalizing a value output by the machine learning model for each mode candidate such that an output value associated with any candidate is equal to or greater than 0 and a value obtained by summing the output values for all the candidates is 1 as an estimation result of the mode.

### Supplementary Note 28

The program according to any one of supplementary notes 23 to 26, in which in estimating the mode, the computer is caused to execute adjusting a belief value of each mode for estimating a mode of state transition of the state prediction target such that a magnitude of an error between a prediction value of the state of the state prediction target predicted a belief value of each mode and by a prediction model of each mode, and the state of the state prediction target becomes smaller by using an online state estimation algorithm or an online convex optimization algorithm.

1. A state prediction apparatus comprising:
at least one storage medium configured to store instructions; and
at least one processor configured to execute the instructions to:
select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time; and
estimate a mode of state transition of the state prediction target at the state prediction start time based on a selected candidate of the mode of state transition of the state prediction target at the state prediction start time, the state data, and the input data.

2. The state prediction apparatus according to claim 1, wherein the at least one processor is further configured to execute the instructions to:
calculate a value related to a state of the state prediction target based on an estimation result of the mode by using a prediction model provided for each mode.

3. The state prediction apparatus according to claim 2, wherein the at least one processor is further configured to execute the instructions to:
select one of the modes among the mode candidates in the estimation of the mode, and
calculate a value related to the state of the state prediction target by using the prediction model associated with the selected mode.

4. The state prediction apparatus according to claim 2, wherein the at least one processor is further configured to execute the instructions to:
calculate, for each of the mode candidates, a belief that a mode of state transition of the state prediction target is the mode, and
calculate, as a value related to the state of the state prediction target, a value obtained by weighting and summing output values of the prediction models associated with each of the mode candidates by a weight based on the belief.

5. The state prediction apparatus according to claim 2, wherein the prediction model is a machine learning model trained using state data indicating a state of the state prediction target and input data indicating an input to the state prediction target.

6. The state prediction apparatus according to claim 2, wherein the at least one processor is further configured to execute the instructions to:
input, to a machine learning model trained using training data having time-series data of the state of the state prediction target and time-series data of the input to the state prediction target as input data to a machine learning model, and one-hot vector having an element for each mode candidate and indicating a correct answer mode as correct answer data, the time-series data of the state of the state prediction target and the time-series data of the input to the state prediction target, and
output a value obtained by normalizing a value output by the machine learning model for each mode candidate such that an output value associated with any candidate is equal to or greater than 0 and a value obtained by summing the output values for all the candidates is 1 as an estimation result of the mode.

7. The state prediction apparatus according to claim 2, wherein the at least one processor is further configured to execute the instructions to:
adjust a belief value of each mode for estimating a mode of state transition of the state prediction target such that a magnitude of an error between a prediction value of the state of the state prediction target predicted by a belief value of each mode and a prediction model of each mode, and the state of the state prediction target becomes smaller by using an online state estimation algorithm or an online convex optimization algorithm.

8. A control apparatus comprising:
at least one storage medium configured to store instructions; and
at least one processor configured to execute the instructions to:
select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time;
estimate a mode of state transition of the state prediction target at the state prediction start time based on a selected candidate of the mode of state transition of the state prediction target at the state prediction start time, the state data, and the input data; and
generate a control command with respect to the state prediction target based on an estimation result of the mode.

9. A state prediction method comprising having a computer to:
select some modes among modes assumed as modes of state transition of a state prediction target as a candidate of a mode of state transition of the state prediction target at a state prediction start time based on state data indicating a state at a time before the state prediction start time of the state prediction target and input data indicating an input to the state prediction target at a time before the state prediction start time; and
estimate a mode of state transition of the state prediction target at the state prediction start time based on a selected candidate of the mode of state transition of the state prediction target at the state prediction start time, the state data, and the input data.
